(19) United States
(12) Patent Application Publication
(10) Pub. No.: US 2023/0268563 A1
(43) Pub. Date: Aug. 24, 2023

(54) CONNECTOR ASSEMBLY FOR BATTERY PACK AND BATTERY PACK INCLUDING THE SAME

(71) Applicant: SK ON CO., LTD., Seoul (KR)

(72) Inventors: Hee Jin LEE, Daejeon (KR); Soo Hwan JO, Daejeon (KR); Yang Kyu CHOI, Daejeon (KR)

(21) Appl. No.: 18/170,534

(22) Filed: Feb. 17, 2023

(30) Foreign Application Priority Data
Feb. 21, 2022 (KR) 10-2022-0022447
Jan. 20, 2023 (KR) 10-2023-0009058

(51) Int. Cl. H01M 10/42; H01M 50/204; H01R 13/64; H01R 13/629; H01R 13/639

(52) U.S. Cl. CPC H01M 10/425; H01M 50/204; H01R 13/64; H01R 13/629; H01R 13/639

(57) ABSTRACT

A connector assembly for a battery pack may include: a first housing configured to support a first terminal; a second housing configured to support a second terminal electrically connected to the first terminal, and coupled to the first housing; and a fixing member detachably coupled to the second housing, and the fixing member is selectively disposed in a first position in which the second housing and the second terminal are mutually aligned, or in a second position in which the first housing and the second housing are prevented from being separated from each other.

### CROSS-REFERENCE TO RELATED APPLICATION (S)

This application claims benefit of priority to Korean. Patent Application No. 10-2022-0022447 filed on Feb. 21, 2022, and 10-2023-0009058 filed on Jan. 20, 2023, in the Korean Intellectual Property Office, the disclosure of which is incorporated herein by reference in its entirety.

### BACKGROUND

### 1. Field

The present disclosure relates to a connector assembly for a battery pack and the battery pack including the same.

### 2. Description of Related Art

Unlike primary batteries, secondary batteries (i.e., battery cells) have been attracting attention as power sources for various mobile devices and electric vehicles due to having the convenience that secondary batteries can be charged and discharged. A battery module is configured by connecting and modularizing the plurality of battery cells, and a battery pack is formed of a high capacity energy storage device by connecting a plurality of battery modules and/or a plurality of battery cells.

As the plurality of battery modules (or battery cells) are arranged in the energy storage device as described above, a connector for stable power and signal transmission between components is applied to the battery modules.

Since a conventional connector is vulnerable to vibrations or impacts applied to an energy storage device, there is a problem in that the connection of the connector may be easily released.

The conventional connector requires an additional fixing structure to solve these vulnerabilities and an additional reinforcing structure to ensure the coupling stability of the connectors themselves, and in this case, the number of components of the connector may increase to cause inefficiency in a manufacture process in the process of assembling the components with each other.

### SUMMARY

The present disclosure has been. derived to solve at least some of the problems in the aforementioned conventional technology, and an aspect of the present disclosure is to provide a connector assembly for a battery pack and the battery pack including the same, having a simple and stable connection structure.

In addition, an aspect of the present disclosure is to provide a connector assembly for a battery pack and the battery pack including the same, for increasing fastening force and space efficiency of a connector using an integral fixing device.

In addition, an aspect of the present disclosure is to provide a connector assembly for a battery pack and the battery pack including the same for increasing assembly performance using a fixing device with a multi-stage assembly structure.

In order to achieve the aspects of the present disclosure, according to an aspect of the present disclosure, a connector assembly for a battery pack may include: a first housing configured to support a first terminal; a second housing configured to support a second terminal electrically connected to the first terminal, and coupled to the first housing; and a fixing member detachably coupled to the second housing, and the fixing member may be configured to align the second housing and the second terminal with each other in a first position, and is configured to prevent the first housing and the second housing from being separated from each other in a second position, and the fixing member may be configured to be selectively disposed in the first position and the second position.

According to example embodiments of the present disclosure, the fixing member may include a first guide portion configured to prevent the fixing member from deviating from the first position by engaging with the second housing.

According to example embodiments of the present disclosure, the first guide portion may have a groove shape, and the second housing may include an insertion protrusion inserted into the first guide portion.

According to example embodiments of the present disclosure, the fixing member may include a second guide portion configured to prevent the fixing member from deviating from the second position by engaging with the insertion protrusion.

According to example embodiments of the present disclosure, the fixing member may be configured to be coupled to the second housing in a first direction, and the first guide portion and the second guide portion may be disposed in the first direction.

According to example embodiments of the present disclosure, the second housing may have an opening configured to accommodate the second terminal, and the fixing member further may include a first insertion portion configured to be inserted into the opening. The first insertion portion may be inserted into the opening when the fixing member is positioned at the first position or the second position.

According to example embodiments of the present disclosure, the second housing may include: a body portion configured to accommodate the second terminal; and a locking unit formed to be elastically deformable and configured to engage with the first housing.

According to example embodiments of the present disclosure, the locking unit may include: a hook configured to hang on the first housing; and a lever connected to the hook.

According to example embodiments of the present disclosure, the fixing member further may include a second insertion portion inserted into a gap between the lever and the body portion to prevent a movement of the lever.

According to example embodiments of the present disclosure, the fixing member may have a state in which the second insertion portion is not inserted into the gap in the first position, and may have a state in which the second insertion portion is inserted into the gap in the second position.

According to example embodiments of the present disclosure, the first housing may include a hook protrusion engaging with the hook.

According to example embodiments of the present disclosure, the second housing may include a locking unit configured to engage with the first housing, and the fixing member may include: a first insertion portion configured to be in contact with the second terminal; and a second insertion portion configured to be in contact with the locking unit, and the first insertion portion and the second insertion portion may be integrally formed.

According to example embodiments of the present disclosure, the fixing member may be configured to be coupled to the second housing in the first direction, and the first insertion portion and the second insertion portion may be disposed in a second direction, perpendicular to the first direction.

According to example embodiments of the present disclosure, as the fixing member is inserted in the first direction, the first insertion portion and the second insertion portion may be configured to be inserted into different positions of the second housing, and the first insertion portion may be configured to be inserted into the second housing before the second insertion portion.

According to example embodiments of the present disclosure, a length of the first insertion portion in the first direction may be longer than a length of the second insertion portion in the first direction

According to another aspect of the present disclosure, a battery pack may include: the connector assembly for a battery pack described above; and a plurality of battery cells electrically connected to the first terminal.

According to example embodiments of the present disclosure, the battery pack may further include: a battery module including a module housing configured to accommodate the plurality of battery cells; and a pack housing configured to accommodate the battery module, and the first housing and the second housing may be exposed to the outside of the module housing.

According to example embodiments of the present disclosure, a connector assembly for a battery pack and the battery pack including the same can have a simple and stable connection structure.

In addition, a connector assembly for a battery pack and the battery pack including the same can increase fastening force and space efficiency of a connector using an integral fixing device.

In addition, a connector assembly for a battery pack and the battery pack including the same can increase assembly performance using a fixing device with a multi-stage assembly structure.

### BRIEF DESCRIPTION OF DRAWINGS

The above and other aspects, features, and advantages of the present disclosure will be more clearly understood from the following detailed description, taken in conjunction with the accompanying drawings, in which:

FIG. 1 is a view exemplarily illustrating a battery module and a battery pack including the same;

FIG. 2 is a perspective view of a connector assembly for a battery pack;

FIG. 3 is an exploded perspective view of a connector assembly for a battery pack;

FIG. 4A is a view exemplarily illustrating a state before a second housing and a fixing member are coupled to each other;

FIG. 4B is a view exemplarily illustrating a state before the first housing and a second housing are coupled to each other;

FIG. 4C is a view exemplarily illustrating a state in which the first housing and the second housing are coupled to each other;

FIG. 4D is a view exemplarily illustrating a state in which the first housing and the second housing are coupled to each other;

FIG. 5 is an assembled cross-sectional view illustrating the connector assembly for a battery pack;

FIG. 6 is a top view of the connector assembly for a battery pack;

FIG. 7 is a cross-sectional view taken along line III-III′ of FIG. 6;

FIG. 8 is a cross-sectional view taken along line IV-IV′ of FIG. 6;

FIG. 9 is a top view of the connector assembly for a battery pack;

FIG. 10 is a. cross-sectional view taken along line V-V′ of FIG. 9; and

FIG. 11 is a cross-sectional view taken along line VI-VI′ of FIG. 9.

### DETAILED DESCRIPTION

Prior to describing the exemplary embodiments in detail, it should be understood that the terms used in the specification and the appended claims should not be construed as being limited to general and dictionary meanings, but interpreted based on the meanings and concepts corresponding to technical aspects of the present disclosure on the basis of the principle that the inventor is allowed to define terms appropriately for the best explanation. Therefore, the description proposed herein is just a preferable example for the purpose of illustrations only, not intended to limit the scope of the disclosure, so it should be understood that other equivalents and modifications could be made thereto without departing from the spirit and scope of the disclosure.

The same reference numeral or symbol written in each accompanying drawing of the specification refers to parts or components that perform substantially the same function. The present inventive concept is described using the same reference numeral or symbol even in different exemplary embodiments for easy description and appreciation. In this aspect, although all components having the same reference numeral are illustrated in a plurality of drawings, the plurality of drawings do not necessarily refer to a single exemplary embodiment.

In this specification, the singular also includes the plural unless specifically stated otherwise in the phrase. It will be further understood that the terms “comprises,” “comprising,” “includes” and/or “including”, when used herein, specify the presence of stated features, integers, steps, operations, elements, components and/or combinations thereof, but do not preclude the presence or addition of one or more other features, integers, steps, operations, elements, components, and/or groups thereof.

In addition, it should be noted in advance that the expressions such as “above,” “upper,” “below”, “beneath,” “lower,” “side,” “front,” and “rear” are based on the direction illustrated in. the drawings, and may be expressed differently if the direction of the object is changed.

In addition, in the present specification and claims, terms including ordinal numbers such as “first” and “second” may be used to distinguish between components. These ordinal numbers are used to distinguish the same or similar components from each other, and the meaning of the terms should not be construed as limited by the use of these ordinal numbers. For example, the components combined with these ordinal numbers should not be construed as limiting the order of use or arrangement of the components. If necessary, the ordinal numbers may be used interchangeably.

Hereinafter, with reference to the drawings, specific embodiments of the present disclosure will be described. However, the scope of the present disclosure is not limited to the suggested embodiments. For example, those skilled in the art who understand the idea of the present disclosure may propose other embodiments included within the scope of the idea of the present disclosure by adding, modifying, or deleting components, but the embodiments described herein have been provided so that this disclosure will be thorough and complete, and will convey the full scope of the disclosure to one of ordinary skill in the art. In the drawings, the shapes and dimensions of elements may be exaggerated for clarity.

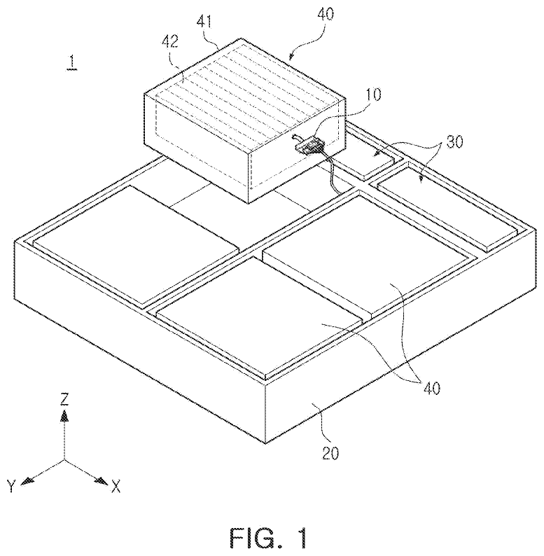

FIG. 1 is a view exemplarily illustrating a battery module 40 and a battery pack 1 including the same.

The battery pack 1 according to example embodiments may include a plurality of battery modules 40 and a pack housing 20 having the battery modules 40 accommodated therein.

The pack housing 20 provides a space for accommodating the battery modules 40.

The pack housing 20 may be formed of a material having sufficient rigidity to protect the battery module 40 from an external impact. For example, at least a portion of the pack housing 20 may be made of a metal material such as aluminum. When the pack housing 20 includes aluminum, thermal energy generated from the battery module 40 may be quickly radiated to the outside of the battery pack 1 due to the excellent thermal conductivity of aluminum.

The battery module 40 may include a plurality of battery cells 42 and a module housing 41 having an internal space in which the battery cells 42 are accommodated.

The battery module 40 may include at least one battery cell 42 capable of charging and discharging to store or discharge electrical energy. For example, the battery module 40 may include a plurality of battery cells 42 formed of secondary batteries such as lithium-ion batteries or nickel-hydrogen batteries.

The battery cell 42 included in the battery module 40 may be composed of an electrode assembly and an exterior material accommodating the electrode assembly. For example, the battery cell 42 may be a pouch-type battery cell 42 in which the electrode assembly is accommodated in an aluminum-coated pouch. Alternatively, the battery cell 42 may be a square-shape battery cell 42 in which the electrode assembly is accommodated in a metal can. However, the specific shape of the battery cell 42 is not limited to the aforementioned descriptions, and the battery cell may be provided in any shape as long as the battery cell can be accommodated in the battery module 40.

The battery cells 42 may be stacked and disposed in one direction. For example, as illustrated in FIG. 1, the plurality of battery cells 42 may be stacked and arranged in a Y-axis direction inside a module housing 41 and may be electrically connected to each other.

The battery module 40 may include a module housing 41 having an internal space in which the battery cell 42 is accommodated. The module housing 41 may include a material having rigidity and protect the battery cell 42 from an external environment of the battery module 40.

The module housing 41 may have a structure surrounding at least a portion of the battery cell 42, and the at least a portion (e.g., a lower surface) of the battery cell 42 may be exposed to the outside of the module housing 41.

The battery pack 1 may further include a control unit 30 capable of controlling the battery module 40 accommodated in the pack housing 20. For example, the control unit 30 may include a battery management system (BMS) serving to monitor thermal and electrical states of the battery module 40 and control charging or discharging situations of the battery module 40. Alternatively, the control unit 30 may include a power relay assembly (PRA) serving. to supply or block a power source of the battery module 40 to or from the outside of the battery pack 1.

The battery pack 1 may include a connector assembly 10 for a battery pack connected to the battery module 40. example, as illustrated in FIG. 1, the connector assembly 10 for a battery pack may be disposed in one side of the module housing 41.

In the following description, the connector assembly 10 for a battery pack may be briefly described as a ‘connector assembly 10.’

The connector assembly 10 may be used to electrically connect the battery module 40 and various components included in the battery pack 1 to each other. For example, the connector assembly 10 may be a control connector used to electrically connect the control unit 30 and the battery module 40 of the pack housing 20 to each other. Alternatively, the connector assembly 10 may be a power connector used to electrically connect any two battery modules 40 to each other.

The battery module 40 may exchange electrical signals with carious components included in the battery pack 1 through the connector assembly 10. For example, thermal and electrical states of the battery module 40 sensed by a sensing module (not illustrated) included in the battery module 40 may be transmitted to the outside of the battery module 40 (e.g., the control unit 30) through the connector assembly 10. Alternatively, the control signal of the control unit 30 may be transmitted to the battery module 40 through the connector assembly 10.

The connector assembly 10 is configured to be coupled to or disconnected from the battery module 40 so that the battery module 40 may be electrically connected to or disconnected from other components according to a user's needs.

Meanwhile, since FIG. 1 only illustrates the structure of the battery pack 1, specific structures of components (e.g., the battery module 40 or the control unit 30) of the battery pack 1 are not limited thereto.

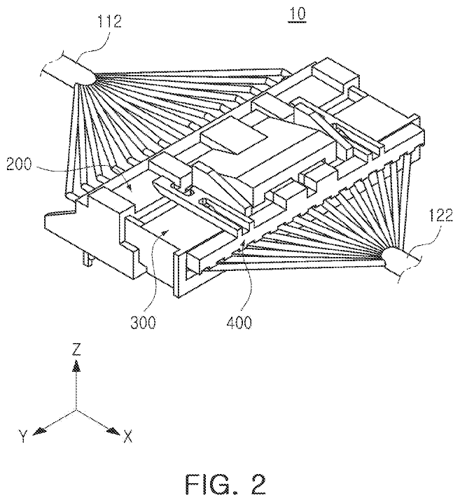

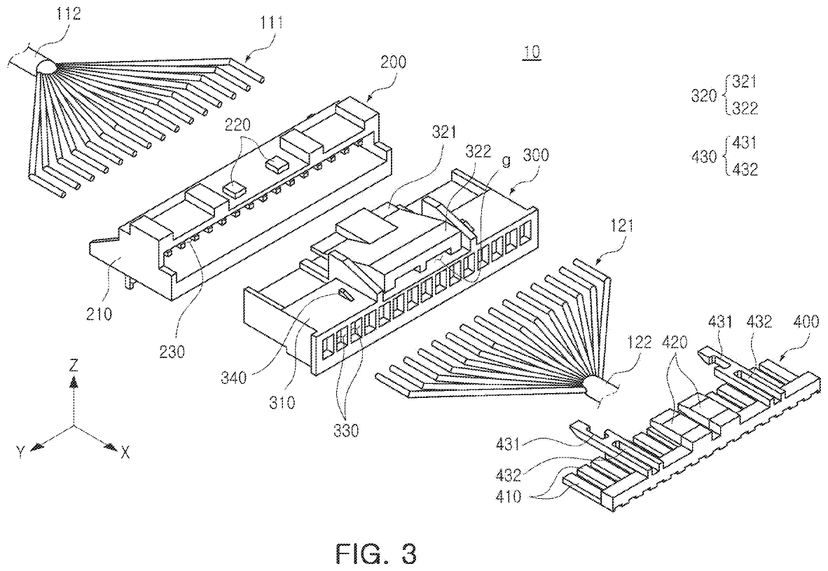

Hereinafter, the connector assembly 10 for a battery pack according to example embodiments of the present disclosure will be described in detail with reference to FIGS. 2 and 3.

FIG. 2 is a perspective view of the connector assembly 10 for a battery pack.

FIG. 3 is an exploded perspective view of the connector assembly 10 for a battery pack.

Since the connector assembly 10 for the battery pack described in FIGS. 2 and 3 corresponds to the connector assembly 10 for the battery pack of FIG. 1, redundant descriptions may be omitted.

The connector assembly 10 may include a first housing 200 and a second housing 300, detachably coupled to each other.

In addition, the connector assembly 10 may include a first terminal 111 and a second terminal 121, formed of a conductive material.

The first housing 200 is configured to support the first terminal 111, and the second housing 300 is configured to support the second terminal 121. For example, the first terminal 111 may be accommodated inside the first housing 200, and the second terminal 121 may be accommodated inside the second housing 300.

Each of the housings 200 and 300 may have openings 230 and 330 so as to expose the terminals 111 and 121 accommodated therein. For example, the first terminal 111 may be exposed to the outside of the first housing 200 through the first opening 230 of the first housing 200. In addition, the second terminal 121 may be exposed to the outside of the second housing 300 through the second opening 330 of the second housing 300. The first terminal 111 and the second terminal 121 may be electrically connected to each other with the coupling of the first housing 200 and the second housing 300.

The first housing 200 and the second housing 300 may have a structure in which the first housing 200 and the second housing 300 engage with and are coupled to each other. For example, the first housing 200 and the second housing 300 are implemented as a male housing and a female housing, respectively, and may be fitted and coupled to each other. However, this is only an example, and the first housing 200 may be implemented as a female housing and the second housing 300 may be implemented as a male housing.

As the first housing 200 and the second housing 300 of the connector assembly 10 are coupled to each other, the first terminal 111 and the second terminal 121 may be electrically connected to each other. Conversely, when the first housing 200 and the second housing 300 that have been coupled to each other are separated from each other, the electrical connection between the first terminal 111 and the second terminal 121 may be released.

That is, the user may electrically connect or disconnect one battery module 40 to or from another component of the battery pack 1 (e.g., another battery module 40 or another control unit 30) by coupling or separating the first housing 200 to or from the second housing 300 of the connector assembly 10.

The first terminal 111 and the second terminal 121 may have a structure in which the first terminal 111 and the second terminal 121 may be in contact with each other. For example, referring to FIG. 3, the first terminal 111 and the second terminal 121 may be configured in a pin type extending in a first direction (X-axis direction), which is a coupling direction between the first housing 200 and the second housing 300. Accordingly, the first terminal 111 and the second terminal 121 may be in contact with each other with the coupling of the first housing 200 and the second housing 300.

However, detailed shapes of the first terminal 111 and the second terminal 121 are not limited to those illustrated in the drawings. Depending on a coupling method of the first housing 200 and the second housing 300, the first terminal 111 and the second terminal 121 may be changed in various shapes.

The first terminal 111 and the second terminal 121 may be connected to wires 112 and 122, respectively. For example, the first wire 112 drawn out from one battery module 40 may be connected to the first terminal 111, and the second wire 122 drawn out from one side of the pack housing 20 may be connected to the second terminal 121. As the first housing 200 and the second housing 300 of the connector assembly 10 are coupled to each other, an electrical circuit connected to the first wire 112, the first terminal 111, the second terminal 121 and the second wire 122 may be formed.

Meanwhile, the first housing 200 and the second housing 300 are formed of an insulating material (e.g., plastic) thereby preventing the user from electrically coming into contact with the first terminal 111 and the second terminal 121 while treating the connector assembly 10.

The connector assembly 10 may have a locking structure capable of preventing the coupling of the first housing 200 and the second housing 300 from being unexpectedly released by external force.

For example, the second housing 300 may include a body portion 310 having the second terminal 121 accommodated therein and a locking unit 320 connected to the body portion 310 to prevent the separation of the first housing 200. Accordingly, the first housing 200 may have a hook protrusion 220 configured to engage with the locking unit 320 of the second housing 300.

Referring to FIG. 3, the hook protrusion 220 may be configured to protrude from one surface of the body portion 210 of the first housing 200 so that the locking unit 320 of the second housing 300 may be caught by the hook protrusion 220. However, the specific shape of the hook protrusion 220 is not limited to that illustrated in the drawings. The hook protrusion 220 is sufficient as long as it may be formed in a structure in which a hook 321 of the second housing 300 may be caught thereby.

The locking unit 320 may include the hook 321 configured to hang on the hook protrusion 220 of the first housing 200 and a lever 322 connected to the hook 321.

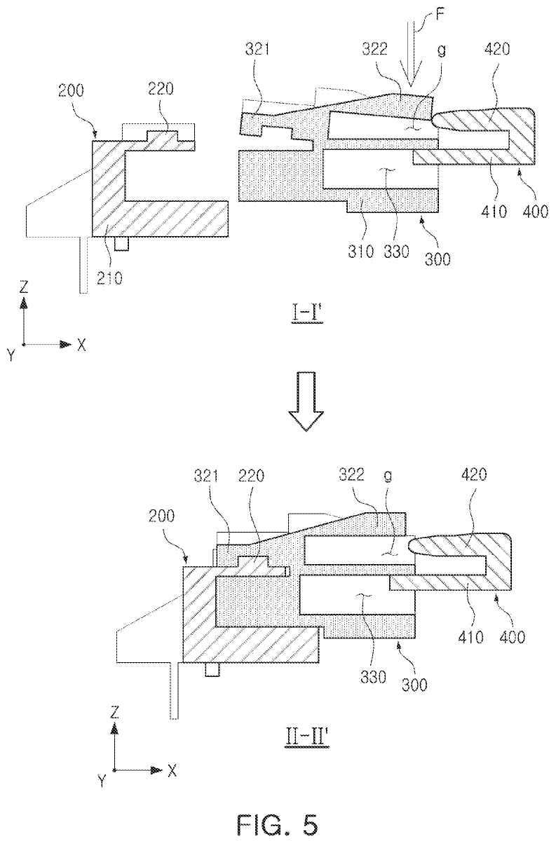

The locking unit 320 may be elastically deformed and configured to engage with the first housing 200 in the process of coupling the first housing 200 to the second housing 300. For example, when the user presses the lever 322 and simultaneously couples the first housing 200 to the second housing 300, the hook 321 connected to the lever 322 may be opened so that the hook projection 220 of the first housing 200 may be easily inserted into the hook 321. Then, when external force applied to the lever 322 is removed, the hook 321 returns to an original position thereof and hangs on the hook protrusion 220. An operation of the locking unit 320 will be described below with reference to FIG. 5.

Referring to FIGS. 2 and 3, when unexpected external force is applied to the locking unit 320 due to continuous vibration or a strong impact, the locking unit 320 may be deformed and the first housing 200 and the second housing 300 may be separated from each other. In order to prevent such separation, the connector assembly 10 may further include a fixing member 400 detachably coupled to the second housing 300 to limit deformation of the locking unit 320.

The fixing member 400 may include a plurality of insertion portions 410 and 420 inserted into the second housing 300. For example, the fixing member 400 may include the first insertion portion 410 inserted into the opening of the second housing 300, and the second insertion portion 420 inserted between the locking unit 320 of the second housing 300 and the body portion 310.

The first insertion portion 410 of the fixing member 400 may be inserted into the second housing 300 to guide the second terminal 121 to be aligned in an accurate position inside the second housing 300.

For example, as the fixing member 400 is coupled to the second housing 300, the first insertion portion 410 may be inserted into the second housing 300 and be in contact with the second terminal 121. In this case, the first insertion portion 410 may pressurize a predetermined pressure while coming into contact with the second terminal 121 and may guide the second terminal 121 to be fixed to a predetermined position inside the second housing 300.

That is, as the fixing member 400 is inserted into the second housing 300, the second terminal 121 may be stably supported inside the second housing 300, and may be connected to the first terminal 111 without deviating from a given position while coupling the first housing 200 to the second housing 300.

The second insertion portion 420 of the fixing member 400 may be inserted between the locking unit 320 and the body portion 310 to prevent the locking unit 320 from being elastically deformed. For example, the second insertion port on 420 may be inserted into a gap g between the lever 322 of the locking unit 320 and the body portion 310 to prevent the lever 322 from moving to the body portion 310 by external force. That is, as the second insertion portion 420 is inserted into the second housing 300, the movement of the lever 322 may be limited to prevent the hook 321 connected to the lever 322 from being opened.

In the following description, a state in which the second insertion portion 420 is inserted into the second housing 300 to the deformation the locking unit 320 is defined as ‘fixation’ of the locking unit 320. That is, when the second insertion portion 420 is not inserted into the second housing 300 and the locking unit 320 is elastically deformable by external force, this may be considered that the locking unit 320 is not fixed. In addition, a state an which the locking unit 320 is deformed by external force and does not hang on the first housing 200 is defined as a ‘release’ of the locking unit 320.

One or more first insertion portions 410 and one or more first second insertion portions 420 may be provided, respectively. For example, a plurality of first insertion portions 410 may be provided corresponding to the number of the second terminals 121. In addition, a plurality of second insertion portions 420 may be provided so as to sufficiently fill the gap g between the locking unit 320 and the body portion 310.

The plurality of first insertion portions 410 and the plurality of second insertion portions 420 may be disposed side by side in a second direction (Y-axis direction) perpendicular to the first direction (X-axis direction), respectively.

In addition, the first insertion portion 410 and the second insertion portion 420 may be arranged to form two lavers in a third direction (Z-axis direction) perpendicular to the first direction (X-axis direction) and the second direction (Y-axis direction). For example, referring to FIG. 3, the plurality of first insertion portions 410 may be disposed in the second direction (Y-axis direction), and the plurality of second insertion portions 420 may be arranged in the second direction (Y-axis direction) in a state in which the second insertion portions 420 are spaced apart from the first insertion portion 410 in the third direction (Z-axis direction).

However, the detailed arrangement and the shapes of the first insertion portion 410 and the second insertion portion 420 are not limited to those illustrated in the drawings. The first insertion portion 410 and the second insertion portion 420 are sufficient as long as they may have a shape capable of being inserted into the second housing 300, and the first insertion portion 410 and the second insertion portion may be deformed into various shapes corresponding to the shape of the second housing 300.

The fixing member 400 may be configured to be coupled to the second housing 300 in the first direction (X-axis direction), and the first insertion portion 410 and the second insertion portion 420 of the fixing member 400 may be configured to extend in a direction parallel to the first direction (X-axis direction), respectively. Accordingly, while the fixing member 400 is inserted into the second housing 300, the first insertion portion 410 and the second insertion portion 420 may be naturally inserted into the second housing 300.

Here, the lengths of the first insertion portion 410 and the second insertion portion 420 in the first direction (X-axis direction) may be different from each other. For example, the first insertion portion 410 may be formed to be longer in the first direction (X-axis direction) than the second insertion portion 420. Accordingly, while the fixing member 400 is inserted into the second housing 300, the first insertion portion 410 may be inserted into the second housing 300 before the second insertion portion 420.

That is, the connector assembly 10 according to example embodiments of the present disclosure may have a multi-stage coupling structure in which in the process of inserting the fixing member 400 into the second housing 300 in the first direction (X-axis direction), the first insertion portion 410 and the second insertion portion 420 are sequentially inserted into the second housing 300 with a mutual time difference.

According to such a structure, the user may appropriately change relative positions of the fixing member 400 and the second housing 300 so that only the first insertion portion 410 is inserted into the second housing 300 and the second insertion portion 420 is not inserted into the second housing 300, or both the first insertion portion 410 and the second insertion portion 420 are inserted into the second housing 300. In other words, the user may appropriately change the relative positions of the fixing member 400 and the second housing 300 so that the locking unit 320 of the second housing 300 may be fixed or the locking unit 320 may be released.

In the connector assembly 10 according to example embodiments of the present disclosure, if at least a portion of the first insertion portion 410 of the fixing member 400 is inserted into the second housing 300 and the second insertion portion 420 is not inserted into the second housing 300, this is defined that the fixing member 400 is in a ‘first position.’ In addition, if both the first insertion portion 410 and the second insertion portion 420 of the fixing member 400 are inserted into the second housing 300, this is defined that the fixing member 400 is in a ‘second position.’

When the fixing member 400 is disposed in the first position, the second terminal 121 may be arranged in a given position inside the second housing 300 by the first insertion portion 410 of the fixing member 400, while the locking unit 320 of the second housing 300 may not be fixed yet. Accordingly, the user may easily connect the first terminal 111 to the second terminal 121 by coupling the first housing 200 and the second housing 300 to each other while releasing the locking unit 320.

When the fixing member 400 is disposed in the second position, elastic deformation of the locking unit 320 of the second housing 300 may be limited by the second insertion portion 420. That is, since the locking unit 320 of the second housing 300 is fixed, the first housing 200 and the second housing 300 may be stably maintained even if the user applies external force to the locking unit 320, or vibrations a impacts is applied the connector assembly 10 due to environmental factors.

The fixing member 400 may further include a guide unit 430 for holding the fixing member 400 and the second housing 300 so that relative positions of the fixing member 400 and the second housing 300 are not changed even when external force having a predetermined level or less is applied to the fixing member 400. For example, the fixing member 400 may include a first guide portion 431 configured to prevent the fixing member 400 from deviating from the first position and a second guide portion 432 configured to prevent the fixing member 400 from deviating from the second position.

Referring to FIG. 3, each of the first guide portion 431 and the second guide portion 432 may be provided to have a groove shape and may be formed to hang on an insertion protrusion 340 provided in the second housing 300. That is, when the fixing member 400 is disposed in the first position, the first guide portion 431 may hang on the insertion protrusion 340 of the second housing 300 to prevent the fixing member 400 from unexpectedly deviating from the first position. In addition, when the fixing member 400 is disposed in the second position, the second guide portion 432 may hang on the insertion protrusion 340 of the second housing 300 to prevent the fixing member 400 from unexpectedly deviating from the second. position.

Meanwhile, the insertion protrusion 340 of the second housing 300 may be formed to have an inclined surface at a side facing the fixing member 400, and an opposite surface thereof may be formed to be perpendicular to the body 310, and accordingly, the fixing member 400 may easily enter the second housing 300, but may make it difficult to deviate in a direction opposite to an entry direction.

The first guide portion 431 and the second guide portion 432 of the fixing member 400 may be disposed in the first direction (X-axis direction). Accordingly, as the fixing member 400 is gradually deeply inserted into the second housing 300, the first guide portion 431 and the second guide portion 432 may sequentially hang on the insertion protrusion 340 of the second housing 300.

However, although FIG. 3 illustrates that the fixing member 400 has both the first guide portion 431 and the second guide portion 432, unlike such illustration, the fixing member 400 may have only the first guide portion 431 or only the second guide portion 432. For example, when the fixing member 400 has only the first guide portion 431, the fixing member 400 may be forcibly fitted into the second housing 300 and fixed in the second position.

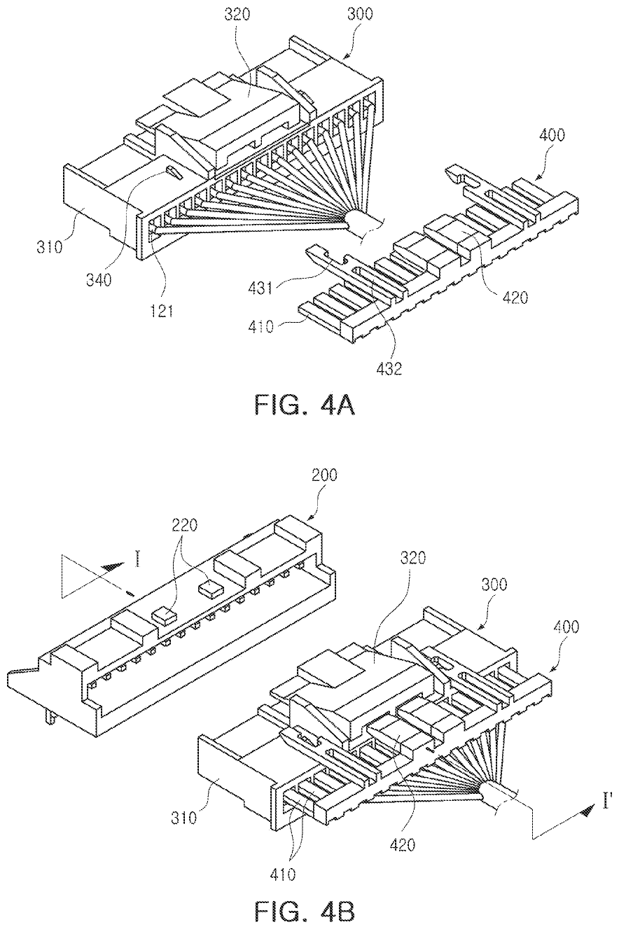

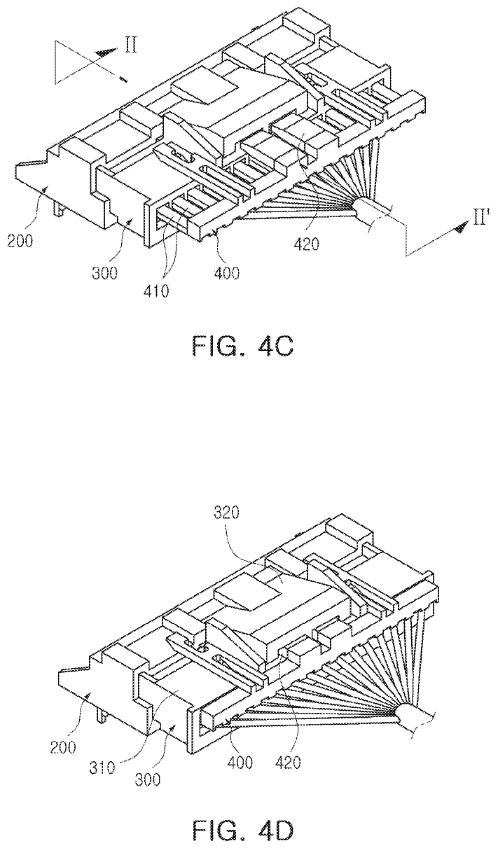

Hereinafter, a coupling process of the connector assembly 10 for a battery pack will be described with reference to FIGS. 4A to 4D.

FIG. 4A is a view exemplarily illustrating a state before the second housing 300 and the fixing member 400 are coupled to each other.

FIG. 4B is a view exemplarily illustrating a state before the first housing 200 and the second housing 300 are coupled to each other.

FIG. 4C is a view exemplarily illustrating a state in which the first housing 200 and the second housing 300 are coupled to each other.

FIG. 4D is a view exemplarily illustrating a state in which the first housing 200 and the second housing 300 are coupled to each other.

Since the connector assembly 10 described in FIGS. 4A to 4D corresponds to the connector assembly 10 described in FIGS. 1 to 3, redundant descriptions may be omitted.

FIGS. 4A to 4D may sequentially illustrate a coupling process of the connector assembly 10. For example, FIG. 4A may illustrate a state in which the fixing member 400 is not yet inserted into the second housing 300. In addition, FIG. 4B may illustrate a state in which the fixing member 400 is disposed in the first position and the first housing 200 and the second housing 300 are not yet coupled to each other. FIG. 4C may illustrate a state where the first housing 200 and the second housing 300 are coupled in a state in which the fixing member 400 is disposed in the first position. FIG. 4D may illustrate a state in which the fixing member 400 is inserted deeper into the second housing 300 and disposed in the second position in a state in which the first housing 200 and the second housing 300 are coupled to each other, and illustrate that the coupling of the connector assembly 10 is completed.

First, referring to FIGS. 4A and 4B, the user may align the position of the second terminal 121 by inserting the fixing member 400 into the second housing 300 to the first position before coupling the first housing 200 to the second housing 300.

When the fixing member 400 is disposed in the first position, a portion of the first insertion portion 410 may be inserted into the second housing 300, and the second insertion portion 420 may not be inserted into the second housing 300. In this case, a portion of the first insertion portion 410 inserted into the second housing 300 may mutually align the second housing 300 and the second terminal 121. For example, the first insertion portion 410 may be in contact with the second terminal 121 to guide the second terminal 121 to be fixed in a position in which the second terminal 121 may be connected to the first terminal 111.

Meanwhile, since the second insertion portion 420 of the fixing member 400 in the first position is not inserted into the second housing 300, the locking unit 320 of the second housing 300 may be elastically deformed by external force.

The user may release the locking unit 320 by applying external force to the locking unit 320 of the second housing 300 in a state in which the second terminal 121 is fixedly al aligned inside the second housing 300, and may couple the second housing 300 and the first housing 200 so as to sufficiently connect the first terminal 111 and the second terminal 121.

Then, when the user removes external force applied to the locking unit 320, as illustrated in FIG. 4G, the first housing 200 hangs on the locking unit 320 of the second housing 300. Accordingly, the first housing 200 and the second housing 300 may stably maintain a state in which they are coupled to each other.

Referring to FIG. 4D, the user may move the fixing member 400 disposed in the first position to the second position and fix the locking unit 320.

When the fixing member 400 is disposed in the second position, both the first insertion portion 410 and the second insertion portion 420 may be inserted into the second housing 300. Specifically, the second insertion portion 420 may enter the gap g between the locking unit 320 and the body portion 310 of the second housing 300, thus preventing the release of the locking unit 320. Accordingly, even if vibration, an impact, or external force is unintentionally applied by the user, the coupling of the first housing 200 and the second housing 300 is blocked from being released.

In the connector assembly 10, the fixing member 400 may be selectively disposed in the first position illustrated in FIG. 4C or the second position illustrated in FIG. 4D. For example, the fixing member 400 may sequentially pass through the first position and the second position while being gradually deeply inserted into the second housing 300.

The user may selectively dispose the fixing member 400 in the first position or the second position and may release or fix the locking unit 320 of the second housing 300.

In the process of inserting the fixing member 400 into the second housing 300, the first insertion portion 410 may be inserted into the second housing 300 before the second insertion portion 420. For example, while the fixing member 400 is inserted into the second housing 300 through the first position to the second position, the first insertion portion 410 may be inserted into the second housing 300 before the second insertion portion 420.

Hereinafter, referring to FIGS. 5 to 11, an appearance of the connector assembly 10 in each coupling step illustrated in FIGS. 4A to 4D will be described in more detail.

Since the connector assembly 10 of FIGS. 5 to 11 correspond to the connector assembly 10 of FIGS. 1 to 4D, the description of FIGS. 1 to 4D may be identically applied to the connector assembly 10 illustrated in FIGS. 5 to 11.

First, FIG. 5 is an assembled cross-sectional view illustrating the connector assembly 10 for a battery pack. FIG. 5 may be a state in which the first housing 200 and the second housing 300 are coupled to each other through operations in FIGS. 4B and 4C. For example, an upper end of FIG. 5 may illustrate that external force is applied to the second housing 300 so as to release the locking unit 320, which is a state before coupling the first housing 200 and the second housing 300, and a lower end of FIG. 5 may illustrate that the locking unit 320 hangs on the locking protrusion 220 of the first housing 200 by removing external force after coupling the first housing 200 and the second housing 300.

As described above with reference to FIG. 3, the locking unit 320 of the second housing 300 may be formed to be elastically deformable.

For example, when the user presses the lever 322 of the locking unit 320, the hook 321 connected to the lever 322 is opened, and when external force applied to the lever 322 is removed, the lever 322 and the hook 321 may be configured to return to original positions thereof by the elasticity of their material.

The user may couple the first housing 200 and the second housing 300 while pressing the lever 322 of the second housing 300 to insert the locking protrusion 220 of the first housing 200 to into the hook 321, and then release the lever 322 to allow the hook 321 to hang on the locking protrusion 220. Then, unless external force pressing the lever 322 is applied, the first housing 200 may not be separated from the second housing 300 by hanging on the hook 321 of the second housing 300.

Due to such a coupling structure, the connector assembly 10 may stably maintain a state in which the first housing 200 and the second housing 300 are coupled without any separation.

In this process, the fixing member 400 may be disposed in the first. position. At least a portion of the first insertion portion 410 of the fixing member 400 may be inserted into the opening 330 of the second housing 300 to align the second terminal 121 at a given position inside the second housing 300. For example, the first insertion portion 410 may pressurize the second terminal 121 to prevent the second terminal 121 from deviating from the given position in the process of coupling the first housing 200 and the second housing 300. Accordingly, the second terminal 121 may be stably connected to the first terminal 111 of the first housing 200 while being aligned by the fixing member 400.

In addition, when the fixing member 400 is disposed in the first position, since the second insertion portion 420 is not yet inserted into the gap g between the body portion 310 and the locking unit 320, the locking unit 320 may be elastically deformed without interfering with the second insertion portion 420.

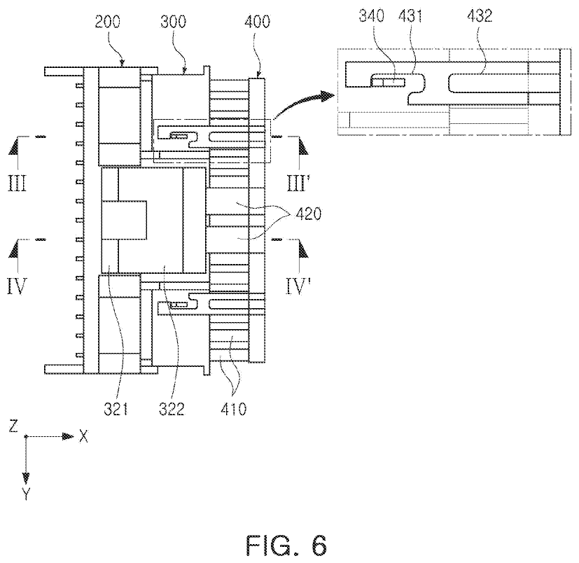

FIG. 6 is a top view of the connector assembly 10 for a battery pack.

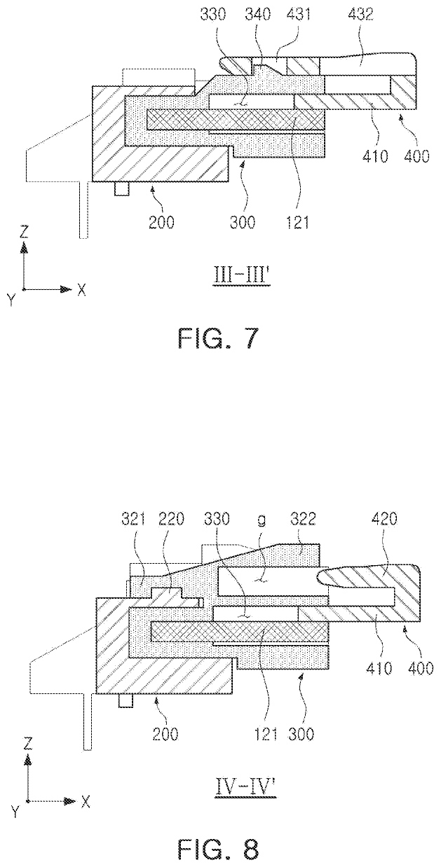

FIG. 7 is a cross-sectional view taken along line I-I′ or FIG. 6.

FIG. 8 is a cross-sectional view taken along line II-II′ of FIG. 6.

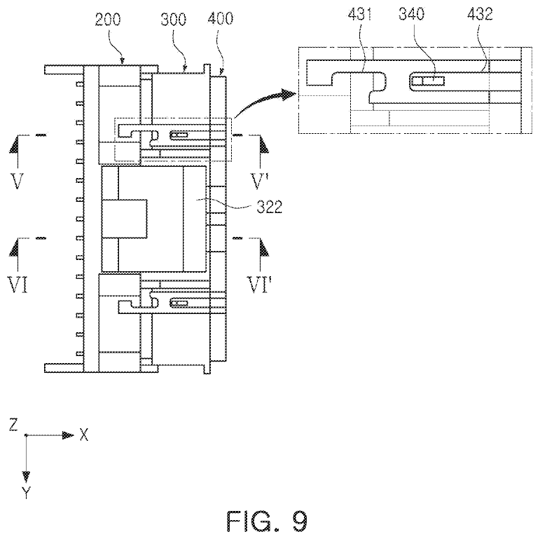

FIG. 9 is a top view of the connector assembly 10 for a battery pack.

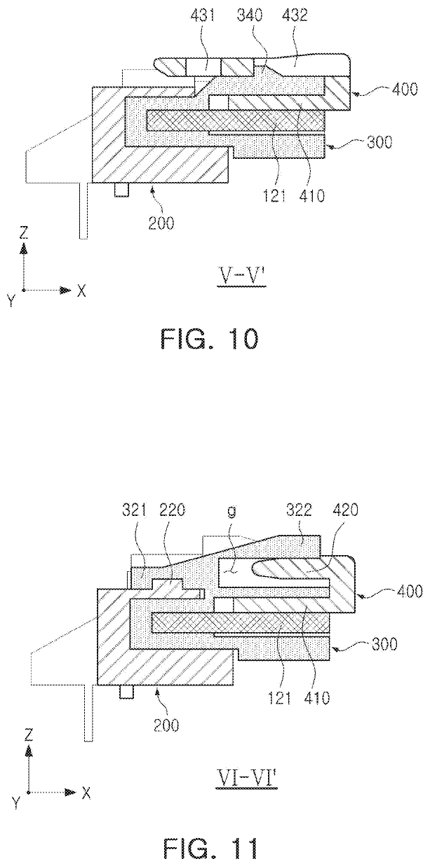

FIG. 10 is a cross-sectional view taken along line III-III′ of FIG. 9.

FIG. 11 is a cross-sectional view taken along line IV-IV′ of FIG. 9.

For example, FIGS. 6 to 8 are a top view or a cross-sectional view of FIG. 4C, and illustrate that the first housing 200 and the second housing 300 may be coupled to each other in a state in which the fixing member 400 is disposed in the first position.

For example, FIGS. 9 to 11 are a top view or a cross-sectional view of FIG. 4D, and illustrate that the first housing 200 and the second housing 300 may be coupled to each other in a state in which the fixing member 400 is disposed in the second position.

The fixing member 400 may be inserted into the second housing 300 in the first direction (X-axis direction), and the first insertion portion 410 and the second insertion portion 420 may extend in the first direction (X-axis direction).

The length of the first insertion portion 410 in first direction (X-axis direction) may be longer than or equal to the length of the second insertion portion 420 in first direction (X-axis direction). For example, referring to FIG. 8, in the first insertion portion 410 and the second insertion portion 420 disposed up and down in the second direction (Y-axis direction), the first insertion portion 410 may be formed to be longer in the first direction (X-axis direction) than the second insertion portion. 420. Accordingly, when the fixing member 400 is disposed in the first position, only the first insertion portion 410 may be inserted into the second housing 300. Then, as the fixing member 400 moves n the first direction (X-axis direction) and is disposed in the second position, both the first insertion portion 410 and the second insertion portion 420 may be inserted into the second housing 300 as illustrated in FIG. 11.

In the first position, the first guide portion 431 of the fixing member 400 may engage with the insertion protrusion 340 of the second housing 300 to prevent the fixing member 400 from easily deviating from the first position.

In the second position, the second guide portion 432 of the firing member 400 may engage with the insertion protrusion 340 of the second housing 300 to prevent the fixing member 400 from easily deviating from the second position.

In the first position, the first insertion portion 410 of The fixing member 400 may enter the opening 330 of the second housing 300 to align the second terminal 121. Meanwhile, the second insertion portion 420 may be disposed in a position that there is no interference with elastic deformation of the locking unit 320. That is, since the second insertion portion 420 does not enter the gap g between the body portion 310 and the locking unit 320 of the second housing 300 in the first position, the user may easily open the hook 321 by pressing the lever 322.

In this state, the user may easily couple the first housing 200 and the second housing 300, or separate the first housing 200 and the second housing 300, coupled to each other.

The user may move the fixing member 400 from the first position to the second position in the first direction (X-axis direction). The fixing member 400 may be inserted into the second housing 300 deeper in the second position than the first position.

In the second position, the first insertion portion 410 of the fixing member 400 may enter the opening 330 of the second housing 300 to align the second terminal 121. Meanwhile, the second insertion portion 420 may be inserted into the gap g between the locking unit 320 and the body portion 310 of the second housing 300 to prevent the lever 322 of the locking unit 320 from being pressed.

Meanwhile, the first terminal 111 is omitted in FIGS. 7, 8, 10, and 11, but referring to the above description, the first terminal 111 and the second terminal 121 may be understood to be electrically connected to each other in the drawings.

Since the connector assembly 10 according to embodiments may couple the first housing 200 to the second housing 300 with the fixing member 400 disposed in the first position, the first terminal 111 and the second terminal 121 may be more stably connected.

In addition, since the fixing member 400 in the connector assembly 10 is configured to fix the locking unit 320 in the second position, the first terminal 111 and the second terminal 121 may be completely prevented from being electrically separated by separating the first housing 200 and the second housing 300 due to vibrations of the vehicle, external impacts, the user's carelessness, or the like.

The connector assembly 10 according to example embodiments of the present disclosure may include the fixing member 400 that may be selectively disposed in the first position or the second position, and may firmly couple the housings after stably connecting the terminals.

Specifically, in the connector assembly 10, the first insertion portion 410 capable of supporting the second terminal 121 and the second insertion portion 420 capable of fixing the locking unit 320 of the second housing 300 may be integrally formed. Accordingly, the number of components constituting the connector assembly 10 may be reduced as compared to the structure in which each fixing component individually serves as the first insertion portion 410 and the second insertion portion 420.

With a decrease in the number of components, the process time in the manufacture or coupling of the connector assembly 10 may be reduced to increase the manufacturing efficiency of the connector assembly 10 and The battery module 40 including the same.

According to the connector assembly 10 of the example embodiments of the present disclosure, a simple and stable connection structure may be implemented in the electrical connection of the battery module 40 or the battery pack 1.

Meanwhile, the connector assembly 10 for a battery pack according to the example embodiments of the present disclosure is used as one of the components of the battery pack 1, and is not intended to limit the scope of the rights. That is, the connector assembly 10 for a battery pack may be widely used to electrically connect different electronic products other than the battery pack 1 described above (e.g., a power source and electronic devices operating with electrical energy output from the power source)

While exemplary embodiments have been shown and described above, it will be apparent to those skilled in the art that modifications and variations could be made without departing from the scope of the present disclosure as defined by the appended claims. In addition, some components may be deleted and implemented in the above-described example embodiments, and each of the embodiments may be combined and implemented with each other.

What is claimed is:

1. A connector assembly for a battery pack, comprising:
a first housing configured to support a first terminal;
a second housing configured to support a second terminal electrically connected to the first terminal, and coupled to the first housing; and
a fixing member detachably coupled to the second housing,
wherein the fixing member is configured to align the second housing and the second terminal with each other in a first position, and is configured to prevent the first housing and the second housing from being separated from each other is a second position, and
wherein the fixing member is configured to be selectively disposed in the first position and the second position.

2. The connector assembly according to claim 1, wherein the fixing member includes a first guide portion configured to prevent the fixing member from deviating from the first position by engaging with the second housing.

3. The connector assembly according to claim 2, wherein the first guide portion has a groove shape, and
the second housing includes an insertion protrusion inserted into the first guide portion.

4. The connector assembly according to claim 3, wherein the fixing member includes a second guide portion configured to prevent the fixing member from deviating from the second position by engaging with the insertion. protrusion.

5. The connector assembly according to claim 4, wherein the fixing member is configured to be coupled to the second housing in a first direction, and the first guide portion and the second guide portion are disposed in the first direction.

6. The connector assembly according to claim 1, wherein the second housing has an opening configured to accommodate the second terminal, and
the fixing member further includes a first insertion portion configured to be inserted into the opening,
wherein the first insertion portion is inserted into the opening when the fixing member is positioned at the first position or the second position.

7. The connector assembly according to claim 1, wherein the second housing comprises:
a body portion configured to accommodate the second terminal; and
a locking unit formed to be elastically deformable and configured to engage with the first housing.

8. The connector assembly according to claim 7, wherein the locking unit comprises:
a hook configured to hang on the first housing; and
a lever connected to the hook.

9. The connector assembly according to claim 8, wherein the fixing member further includes a second insertion portion inserted into a gap between the lever and the body portion to prevent a movement of the lever.

10. The connector assembly according to claim 9, wherein the fixing member has a state in which the second insertion portion is not inserted into the gap in the first position, and has a state in which the second insertion portion is inserted into the gap in the second position.

11. The connector assembly according to claim 8, wherein the first housing includes a book protrusion engaging with the hook.

12. The connector assembly according to claim 1, wherein the second housing includes a locking unit configured to engage with the first housing, and
the fixing member comprises:
a first insertion portion configured to be in contact with the second terminal; and
a second insertion portion configured to be in contact with the locking unit,
wherein the first insertion portion and the second insertion portion. are integrally formed.

13. The connector assembly according to claim 12, wherein the fixing member is configured to be coupled. to the second housing in the first direction, and
the first insertion portion and the second insertion portion are disposed in a second direction, perpendicular to the first direction.

14. The connector assembly according to claim 13, wherein. as the fixing member is inserted in the first direction, the first insertion portion and the second insertion portion are configured to be inserted into different positions of the second housing, and
the first insertion portion is configured to be inserted into the second housing before the second insertion portion.

15. The connector assembly according to claim 13, wherein a length of the first insertion portion in the first direction is longer than a length of the second insertion portion in the first direction.

16. A battery pack comprising:
the connector assembly according to claim 1; and
a plurality of battery cells electrically connected to the first terminal.

17. The battery pack according to claim 16, further comprising:
a battery module including a module housing configured to accommodate the plurality of battery cells; and
a pack housing configured to accommodate the battery module,
wherein the first housing and the second housing are exposed to the outside of the module housing.
